(19) United States
(12) Patent Application Publication
(10) Pub. No.: US 2010/0252005 A1
(43) Pub. Date: Oct. 7, 2010

(54) EVAPORATIVE FUEL TREATMENT APPARATUS FOR MOTOR VEHICLE

(75) Inventors: Masakazu Kitamoto, Shimotsuke-shi (JP); Koichi Hidano, Shimotsuke-shi (JP); Masaru Oku, Sakura-shi (JP)

Correspondence Address: CARRIER BLACKMAN AND ASSOCIATES, 43440 WEST TEN MILE ROAD, EATON CENTER, NOVI, MI, 48375, US

(73) Assignee: HONDA MOTOR CO., LTD., MINATO-KU, TOKYO (JP)

(21) Appl. No.: 12/746,391

(22) PCT Filed: Nov. 10, 2008
(86) PCT No.: PCT/JP2008/070432

§ 371 Date: Jun. 4, 2010

(30) Foreign Application Priority Data
Jan. 18, 2008 (JP) 2008-009390

(51) Int. Cl. F02M 33/08

(52) U.S. Cl. 123/518

(57) ABSTRACT

An evaporative fuel treatment apparatus for a motor vehicle of the present invention treats an evaporative fuel produced in a fuel tank mounted in a motor vehicle or an evaporative fuel in an evaporative fuel reservoir for temporarily storing the evaporative fuel produced in the fuel tank and returns the evaporative fuel to the fuel tank. The evaporative fuel treatment apparatus is activated, while the motor vehicle is parked, by use of electric power supplied from an outside of the motor vehicle or electric power supplied from a natural-energy power generator mounted in the motor vehicle.

### TECHNICAL FIELD

The present invention relates to an evaporative fuel treatment apparatus for a motor vehicle.

Priority is claimed on Japanese Patent Application No. 2008-009390, filed on Jan. 18, 2008, the contents of which are incorporated herein by reference.

### BACKGROUND ART

In some motor vehicles with a fuel tank, a reservoir (for example, a canister) for temporarily storing an evaporative fuel produced in the fuel tank is provided, and the evaporative fuel in the fuel tank or the evaporative fuel stored in the reservoir is treated by being combusted in an engine. In addition, a technique is proposed in which the evaporative fuel in the fuel tank or the evaporative fuel stored in the reservoir is subjected to a treatment such as concentration at appropriate timing, and is then returned to the fuel tank.

When fuel is supplied to a fuel tank, a large quantity of evaporative fuel is produced in the fuel tank. If the evaporative fuel is to be adsorbed by a canister, there is no choice but to make a content of the canister large. Therefore, for example, Patent Document 1 discloses an evaporative fuel treatment apparatus that makes it possible to make a capacity of a canister low in which, during a fuel supply, a pump is used to take in an evaporative fuel in a fuel tank and liquefied the evaporative fuel, and return the liquefied fuel into the fuel tank.

Patent Document 2 discloses a technique related to the present invention, in which a capacitor as a power accumulator of an electric automobile or a hybrid motor vehicle is charged from a commercial power source with plug-in system.

[Patent Document 1] Japanese Unexamined Patent Application, First Publication No. 2004-132263

[Patent Document 2] Japanese Unexamined Patent Application, First Publication No. 2007-143374

### DISCLOSURE OF INVENTION

### Problems to be Solved by the Invention

Incidentally, as a source of power for operating an apparatus for treating an evaporative fuel as described above, a negative pressure produced in an engine or electric power stored in a battery mounted in the motor vehicle is used.

However, for example, in hybrid motor vehicles whose drive source includes an engine and an electric motor, the frequency with which the engine is operated is low. Therefore, even if an evaporative fuel is to be combusted, there are cases where the evaporative fuel fails to be combusted when it should be treated. Furthermore, if the evaporative fuel is treated, during traveling in motor drive mode, by use of electric power of the in-vehicle power accumulator, mileage traveled in motor drive mode becomes short because the capacity of the power accumulator has a limitation. This leads to a decrease in fuel consumption.

Furthermore, if a negative pressure of an intake manifold is low as is the case with a direct-injection engine, there are cases where it is not possible to introduce an evaporative fuel into the engine.

In the invention described in the aforementioned Patent Document 1, the evaporative fuel is treated during refueling. However, the engine is at rest during refueling. Therefore, also in this case, it is not possible to combust the evaporative fuel in the engine. As a result, the evaporative fuel is treated by use of electric power of the power accumulator, leading to a decrease in the remaining charge of the power accumulator. Consequently, mileage traveled in motor drive mode becomes short. This leads to a decrease in fuel consumption.

Therefore, it is an object of this invention to provide an evaporative fuel treatment apparatus for a motor vehicle capable of treating an evaporative fuel without using electric power of a power accumulator or electric power functioning as motive power while a motor vehicle is driven.

### Means for Solving the Problems

In order to solve the above problems and achieve such an object, the present invention adopts the followings.

(1) An evaporative fuel treatment apparatus for a motor vehicle according to the present invention is an evaporative fuel treatment apparatus for a motor vehicle that treats an evaporative fuel produced in a fuel tank mounted in a motor vehicle or an evaporative fuel in an evaporative fuel reservoir for temporarily storing the evaporative fuel produced in the fuel tank and returns the evaporative fuel to the fuel tank, the evaporative fuel treatment apparatus being activated, while the motor vehicle is parked, by use of electric power supplied from an outside of the motor vehicle or electric power supplied from a natural-energy power generator mounted in the motor vehicle.

According to the evaporative fuel treatment apparatus for a motor vehicle as set forth in the above (1), it is possible to treat an evaporative fuel without using the motive force during the driving of the motor vehicle, and by use of as little electric power as possible of the power accumulator mounted in the motor vehicle.

In addition, it is possible to utilize the evaporative fuel again as a fuel after it is returned to the fuel tank.

In the present embodiment, the natural-energy power generator refers to an apparatus capable of using natural energy such as solar rays even when the motor vehicle is at rest, and includes a photovoltaic.

(2) It is preferable that the motor vehicle be a hybrid motor vehicle traveling on wheels that are driven with an engine and an electric motor as drive sources.

In the case of the above (2), it is possible to improve the fuel consumption of the hybrid motor vehicle and to extend its cruising distance.

(3) It is preferable that the evaporative fuel treatment apparatus for a motor vehicle further include: a gas separation membrane that separates the evaporative fuel into a fuel concentrated vapor and a fuel lean vapor; and a pump that is driven by the electric power to generate a pressure difference between an inflow side and an outflow side of the gas separation membrane.

In the case of the above (3), it is possible to separate the evaporative fuel into a fuel concentrated vapor and a fuel lean vapor.

(4) It is preferable that the evaporative fuel treatment apparatus for a motor vehicle be activated by the electric power even if the motor vehicle is traveling, in the case where a condition for purging the evaporative fuel to the engine is not satisfied when an internal pressure in the fuel tank exceeds a predetermined value or an amount of the evaporative fuel in the evaporative fuel reservoir exceeds a predetermined value.

In the case of the above (4), it is possible to treat the evaporative fuel even when the evaporative fuel is not allowed to be combusted in the engine while the motor vehicle is traveling.

### ADVANTAGEOUS EFFECTS OF INVENTION

According to the evaporative fuel treatment apparatus for a motor vehicle as set forth in the above (1), it is possible to treat the evaporative fuel without using the motive force during the driving of the motor vehicle, and by use of as little electric power as possible of the power accumulator mounted in the motor vehicle. In addition, since the evaporative fuel is returned to the fuel tank, it is possible to utilize the evaporative fuel again as a fuel. Therefore, it is possible to improve the fuel consumption of the motor vehicle and to extend its cruising distance.

In the case of the above (2), it is possible to improve the fuel consumption of the hybrid motor vehicle and to extend its cruising distance.

In the case of the above (3), it is possible to separate the evaporative fuel into a fuel concentrated vapor and a fuel lean vapor. This enables reuse of the fuel concentrated vapor by returning it to the fuel tank or by other methods.

In the case of the above (4), it is possible to treat the evaporative fuel even when the evaporative fuel is not allowed to be combusted in the engine while the motor vehicle is traveling.

### BRIEF DESCRIPTION OF THE DRAWINGS

FIG. 1 is a schematic block diagram showing an evaporative fuel treatment apparatus for a motor vehicle according to one embodiment of the present invention.

FIG. 2 is a block diagram showing an electric power supply system to a pump of the evaporative fuel treatment apparatus for a motor vehicle.

### DESCRIPTION OF THE REFERENCE SYMBOLS

1: evaporative fuel treatment apparatus for a motor vehicle
10: fuel tank
22: gas separation membrane
50: canister (evaporative fuel reservoir)
61: pump
100: commercial power source

### BEST MODE FOR CARRYING OUT THE INVENTION

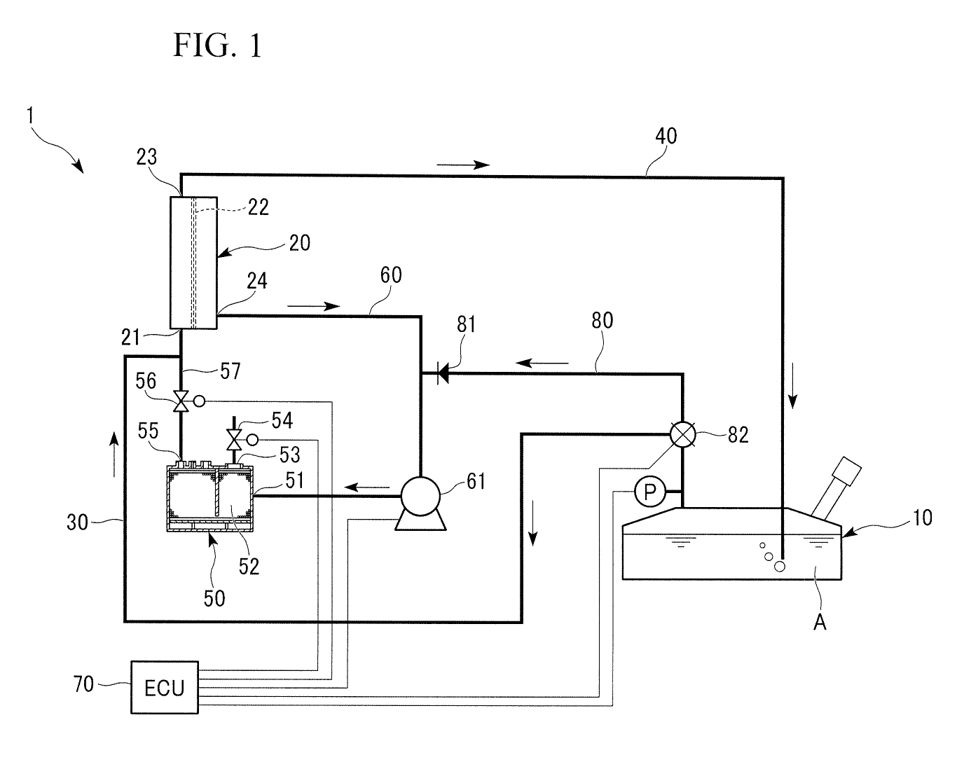

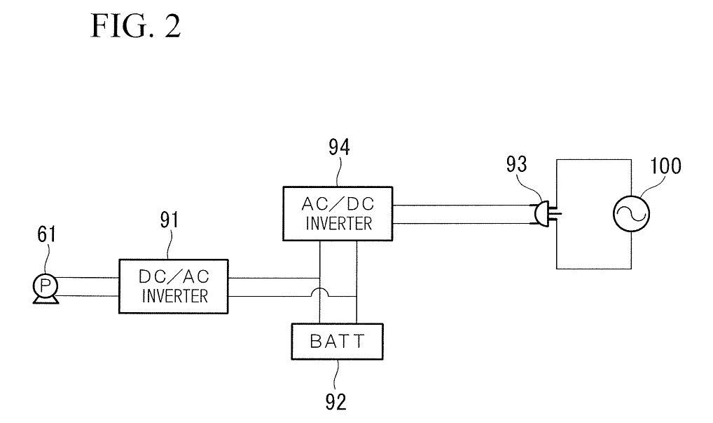

Hereunder is a description of an embodiment of an evaporative fuel treatment apparatus for a motor vehicle according to the present invention with reference to FIG. 1 and FIG. 2.

An evaporative fuel treatment apparatus for a motor vehicle of the present embodiment is mounted in a hybrid motor vehicle. The hybrid motor vehicle is provided with an engine and an electric motor as its drive sources. The hybrid motor vehicle travels with a drive force of at least one of the two being transmitted to its wheels. When the hybrid motor vehicle travels in motor drive mode, electric power is supplied from a power accumulator (for example, a battery, capacitor, or the like) mounted in the motor vehicle to an electric motor for traveling (hereinafter, abbreviated to travel motor). Furthermore, for example in deceleration, the travel motor is capable of functioning as a power generator, allowing regenerative power to be charged in the power accumulator. In addition, the hybrid motor vehicle is a plug-in hybrid motor vehicle, which is connected to, for example, a home-use commercial power source during the time when a motor vehicle is at rest, to thereby charge the power accumulator.

An evaporative fuel treatment apparatus 1 for a motor vehicle shown in FIG. 1 is for treating an evaporative fuel produced in a fuel tank 10 that is mounted in a motor vehicle for storing fuel A for an engine (for example, gasoline or light oil).

The evaporative fuel treatment apparatus 1 includes: a fuel tank 10 for storing fuel A; a gas separation membrane module 20 that separates a fuel vapor (evaporative fuel), which has been produced from the fuel A vaporized in the fuel tank 10, into a fuel concentrated vapor and a fuel lean vapor; a first passage 30 that communicates the fuel tank 10 with the gas separation membrane module 20; a fuel concentrated vapor exhaustion passage 40 as a fuel vapor dissolution device that introduces the fuel concentrated vapor separated by the gas separation membrane module 20 into the fuel tank 10 to dissolve it into the fuel A; a canister (evaporative fuel reservoir) 50 that adsorbs a fuel vapor in the fuel lean vapor; a fuel lean vapor exhaustion passage 60 that communicates the gas separation membrane module 20 with the canister 50 for introducing the fuel lean vapor from the gas separation membrane module 20 to the canister 50; a second passage 80 that is branched from the first passage 30 and communicates with the fuel lean vapor exhaustion passage 60; a passage switching device 82 that is disposed at a branch point between the first passage 30 and the second passage 80; and electronic control unit 70.

The fuel tank 10 includes a pressure gauge P for detecting an internal pressure in the fuel tank 10.

The internal pressure in the fuel tank 10 is increased by a fuel vapor that is produced from the fuel A, stored in the fuel tank 10, being volatilized. The fuel tank 10 is in communication with an introduction port 21 (described later) of the gas separation membrane module 20 via the first passage 30. Furthermore, the fuel tank 10 is in communication with an introduction port 51 (described later) of the canister 50 via the second passage 80 branched from the first passage 30 and via the fuel lean vapor exhaustion passage 60 that is in communication with the second passage 80.

The gas separation membrane module 20 includes: an introduction port 21 that introduces a fuel vapor produced in the fuel tank 10; a gas separation membrane 22 that separates the fuel vapor introduced from the introduction port 21 into a fuel concentrated vapor and a fuel lean vapor; a fuel concentrated vapor exhaustion port 23 that is disposed on an inflow side of the gas separation membrane 22 for exhausting the fuel concentrated vapor; and a fuel lean vapor exhaustion port 24 that is disposed on an outflow side of the gas separation membrane 22 for exhausting the fuel lean vapor.

The introduction port 21 is disposed on an inflow side of the gas separation membrane 22 and is in communication with the fuel tank 10 via the first passage 30. The fuel concentrated vapor exhaustion port 23 is in communication with the fuel tank 10 via the fuel concentrated vapor exhaustion passage 40. An end on the fuel tank 10 side of the fuel concentrated vapor exhaustion passage 40 is in communication with somewhere in the fuel A. The fuel lean vapor exhaustion port 24 is in communication with the introduction port 51 (described later) of the canister 50 via the fuel lean vapor exhaustion passage 60.

As the gas separation membrane 22 of the gas separation membrane module 20, a porous membrane with different permeability rate according to the size of the gas molecules is used. Materials for the porous membrane include, for example, a resin material such as polyimide, polysulfone, and fluoroplastic, and an inorganic material such as carbon and zeolite. It is preferable that, as for the gas separation membrane 22, a ratio of permeability rate of n-butane to nitrogen is not less than 4.

The canister 50 includes: an introduction port 51 that introduces a fuel lean vapor exhausted from the fuel lean vapor exhaustion port 24 of the gas separation membrane module 20; an adsorption portion 52 that adsorbs a fuel vapor in the fuel lean vapor introduced from the introduction port 51; a first exhaustion port 53 that exhausts a vapor, from which the fuel vapor has been removed through the action of the adsorption portion 52, to the outside air; an adsorption amount detection device (not shown in the figure) that detects an amount of the fuel vapor adsorbed by the adsorption portion 52; and a second exhaustion port 55 that exhausts the fuel vapor detached from the adsorption portion 52 and introduces it to the introduction port 21 of the gas separation membrane module 20.

The first exhaustion port 53 of the canister 50 is provided in the vicinity of the introduction port 51. The second exhaustion port 55 is provided at a position spaced from the introduction port 51. The first exhaustion port 53 and the second exhaustion port 55 are provided with a first control valve 54 and a second control valve 56, respectively. Opening/closing operations of the first control valve 54 and the second control valve 56 are controlled by the electronic control unit 70 in accordance with a detection value by the adsorption amount detection device. The first exhaustion port 53 is connected to a pipe open to the outside air. The second exhaustion port 55 is in communication with the introduction port 21 of the gas separation membrane module 20 via a connection pipe 57 and the first passage 30.

The adsorption portion 52 of the canister 50 is filled with a material having a property of adsorbing a fuel vapor. Such a material is not particularly limited. For example, activated carbon may be used. Activated carbon adsorbs a fuel vapor when exposed to a mixture gas including a high concentration of fuel vapor, and detaches a fuel vapor when exposed to a mixture gas with a concentration of fuel vapor not more than a predetermined value. With the utilization of this property of activated carbon, the canister 50 is allowed to repeat the adsorption and detachment of a fuel vapor.

The adsorption amount detection device provided in the canister 50 is not particularly limited. For example, a device for detecting a remaining amount of fuel vapor included in the vapor exhausted from the first exhaustion port 53 may be used. Examples of such a detection device include a hydrocarbon concentration meter and a weight measuring unit for the canister. The detection device may be one that measures a content of fuel vapor included in the vapor exhausted from the first exhaustion port 53 to assume an adsorbed amount of fuel vapor in the canister 50.

The fuel lean vapor exhaustion passage 60 includes a pump 61 that communicates the fuel lean vapor exhaustion port 24 of the gas separation membrane module 20 with the introduction port 51 of the canister 50 and that is driven by an electric motor for reducing a pressure on the outflow side of the gas separation membrane 22. The pump 61 is not particularly limited. For example, a conventionally known vacuum pump may be used.

The second passage 80 is branched from the first passage 30 and is in communication with the fuel lean vapor exhaustion passage 60 on the upstream side of a region where the fuel lean vapor exhaustion passage 60 communicates with the pomp 61, that is, the side of the fuel lean vapor exhaustion port 24. The second passage 80 is provided with a check valve 81 that prevents a fuel vapor from flowing back from the fuel lean vapor exhaustion passage 60 to the first passage 30. This can prevent a back-flow of a fuel vapor from the canister 50 to the first passage 30, and consequently to the fuel tank 10 when the pump 61 is at rest.

The passage switching device 82 provided at the branch point between the first passage 30 and the second passage 80 switches between the first passage 30 and the second passage 80. The operation of switching the passages by the passage switching device 82 is controlled by the electronic control unit 70 in accordance with a detection value of the adsorption amount detection device.

Based on the input from the detection value of the pressure gauge P and the detection value of the adsorption amount detection device, the electronic control unit 70 controls the opening/closing of the first control valve 54 and the second control valve 56, the start/stop of the pump 61, and the switching of the passages by the passage switching device 82.

As shown in FIG. 2, to an electric motor (not shown in the figure) for driving the pump 61, electric power is supplied from a battery (power accumulator) 92 via a DC/AC inverter 91 in normal time such as during traveling of the motor vehicle. The battery 92 supplies electric power also to a travel motor (not shown in the figure). Furthermore, it is configured such that regenerative electric power is charged when the travel motor is functioned as a power generator at the time of deceleration or the like of the motor vehicle.

Furthermore, as described above, the motor vehicle is a plug-in hybrid vehicle. Therefore, the motor vehicle includes a plug 93 connectable to, for example, a home-use commercial power source 100. Therefore, when the plug 93 is connected to the home-use commercial power source 100 while the motor vehicle is parked, an alternating current that is input via the plug 93 is converted to a direct current by an in-vehicle AC/DC inverter 94. This charges the battery 92.

Furthermore, while the battery 92 is being charged from the commercial power source 100, electric power can be supplied to the electric motor for driving the pump 61 via the AC/DC inverter 94 and the DC/AC inverter 91. In such a case, it is possible to supply an alternating current to the pump 61 directly from the commercial power source 100, to thereby drive the pump 61.

Next is a description of an operation of the evaporative fuel treatment apparatus 1.

In the hybrid motor vehicle of the present embodiment, the plug 93 is connected to the commercial power source 100 during parking, to thereby charge the battery 92 from the commercial power source 100. At this time, electric power of the commercial power source 100 is supplied to the electric motor for driving the pump 61 via the AC/DC inverter 94 and the DC/AC inverter 91, to thereby activate the pump 61. With the activation of the pump 61, the fuel vapor in the fuel tank 10 and the fuel vapor adsorbed by the canister 50 are treated by the evaporative fuel treatment apparatus 1.

During the traveling of the hybrid motor vehicle, if an internal pressure in the fuel tank 10 exceeds a predetermined value or the adsorption amount of the fuel vapor adsorbed by the canister 50 exceeds a predetermined value, then top priority is given to purge the fuel vapor in the fuel tank 10 and the fuel vapor adsorbed by the canister 50 into the engine via a purge pipe (not shown in the figure) through an intake negative pressure of the engine, to thereby combust the fuel vapors in the engine.

In the case where an internal pressure in the fuel tank 10 exceeds a predetermined value or in the case where, although the adsorption amount of the fuel vapor adsorbed by the canister 50 exceeds a predetermined value, a condition for purging the fuel vapor into the engine is not satisfied, electric power is supplied from the battery 92 to the electric motor for driving the pump 61, to thereby activate the pump 61, if enough charge is left in the battery 92. With the activation of the pump 61, the fuel vapor in the fuel tank 10 and the fuel vapor adsorbed by the canister 50 are treated by the evaporative fuel treatment apparatus 1. As a result, the evaporative fuel can be treated even when it is not possible to combust the evaporative fuel in the engine while the motor vehicle is traveling.

Furthermore, when the remaining charge of the battery 92 becomes low, the engine is started to charge the battery 92. In that case, the fuel vapor purged again into the engine to combust them so as to use as little electric power as possible that is obtained through power generation.

The technique of purging the fuel vapor in the fuel tank 10 and the fuel vapor adsorbed by the canister 50 into the engine during traveling of the hybrid motor vehicle to combust them in the engine is well known. Therefore, detailed description thereof will be omitted.

Here, the description is for the case where the evaporative fuel treatment apparatus 1 is activated during traveling of the hybrid motor vehicle, and electric power is supplied to the electric motor for driving the pump 61 to activate the pump 61, to thereby treat the fuel vapor in the fuel tank 10 and the fuel vapor adsorbed by the canister 50 by means of the evaporative fuel treatment apparatus 1.

When the fuel A is vaporized in the fuel tank 10 to increase the internal pressure in the fuel tank 10 to a value not less than a predetermined value, the pressure gauge P provided in the fuel tank 10 detects this. Then, the electronic control unit 70 activates the pump 61, causes the passage switching device 82 to switch the passage to the first passage 30, opens the first control valve 54, and closes the second control valve 56. The activation of the pump 61 produces a pressure difference between the outflow side and inflow side of the gas separation membrane 22 of the gas separation membrane module 20, causing the gas present on the inflow side to permeate through the gas separation membrane 22. As a result, the inflow side of the gas separation membrane 22 comes to be less pressurized than the interior of the fuel tank 10. This causes the fuel vapor in the fuel tank 10 to flow into the gas separation membrane module 20 from the introduction port 21 via the first passage 30. Of the fuel vapor that has been flowed into the gas separation membrane module 20, the air component such as oxygen and nitrogen permeates through the gas separation membrane 22 faster than the fuel vapor component. Therefore, the fuel vapor is concentrated on the inflow side of the gas separation membrane 22 into a fuel concentrated vapor. The fuel concentrated vapor is exhausted from the fuel concentrated vapor exhaustion port 23 to be introduced into the fuel tank 10 via the fuel concentrated vapor exhaustion passage 40, and is then dissolved in the fuel A.

On the other hand, the fuel lean vapor having permeated through the gas separation membrane 22 passes through the fuel lean vapor exhaustion passage 60, and then flows into the canister 50 from the introduction port 51, where the fuel vapor component included in the fuel lean vapor is adsorbed by the adsorption portion 52. The vapor after the adsorption of the fuel vapor passes from the first exhaustion port 53 to the first control valve 54, and is then exhausted to the outside air.

With the repetition of the above operation, the fuel vapor produced in the fuel tank 10 is partly concentrated and dissolved in the fuel A, and is partly adsorbed by the adsorption portion 52 of the canister 50. As a result, it is possible to prevent the internal pressure in the fuel tank 10 from increasing to a predetermined level or higher.

On the other hand, if the adsorption amount of the fuel vapor detected by the adsorption amount detection device provided in the canister 50 exceeds a preset predetermined value, the electronic control unit 70 causes the passage switching device 82 to switch the passage from the first passage 30 to the second passage 80. At the same time, the electronic control unit 70 closes the first control valve 54 and opens the second control valve 56. When the fuel concentrated vapor, which has been introduced into the fuel tank 10 via the fuel concentrated vapor exhaustion passage 40, is dissolved in the fuel A, a fuel vapor including only a slight fuel vapor component is left in the fuel tank 10. The fuel vapor including only a slight fuel vapor component flows from the fuel tank 10 into the fuel lean vapor exhaustion passage 60 via the second passage 80 through the drive force of the pump 61, and is then mixed with the fuel lean vapor. When flowing from the introduction port 51 into the canister 50, the fuel lean vapor after mixture stimulates the detachment of the fuel vapor component in the adsorption portion 52, and is then exhausted from the second exhaustion port 55 together with the detached fuel vapor. The exhausted vapor, after passing through the second control valve 56, flows into the gas separation membrane module 20 at the introduction port 21, and is then separated into a fuel concentrated vapor and a fuel lean vapor. The fuel concentrated vapor is sent to the fuel tank 10 via the fuel concentrated vapor exhaustion passage 40, and the fuel component in the fuel concentrated vapor is dissolved in the fuel A. On the other hand, the fuel lean vapor is resent to the canister 50 via the fuel lean vapor exhaustion passage 60. With the repetition of this series of treatments, the detachment of the fuel vapor component from the adsorption portion 52 is stimulated.

If the detection value of the pressure gauge P is not less than the predetermined value when the adsorption amount of the fuel vapor detected by the adsorption amount detection device becomes less than a predetermined value, the electronic control unit 70 again causes the passage switching device 82 to switch the passage from the second passage 80 to the first passage 30, opens the first control valve 54, and closes the second control valve 56. As a result, the separation of the fuel vapor by the gas separation membrane module 20 and the adsorption of the fuel vapor by the canister 50 are repeated.

On the other hand, if the detection value of the pressure gauge P is less than the predetermined value when the adsorption amount of the fuel vapor detected by the adsorption amount detection device becomes less than the predetermined value, the pump 61 stops and the evaporative fuel treatment apparatus 1 stops.

Next is a description of the case where, when the battery 92 is charged from the commercial power source 100 while the hybrid motor vehicle is parked, electric power of the commercial power source 100 is supplied to the electric motor for driving the pump 61 via the AC/DC inverter 94 and the DC/AC inverter 91 to activate the pump 61, to thereby treat the fuel vapor in the fuel tank 10 and the fuel vapor adsorbed by the canister 50 by means of the evaporative fuel treatment apparatus 1.

In this case, if the internal pressure in the fuel tank 10 that is detected by the pressure gauge P becomes less than the predetermined value, and if the adsorption amount of the fuel vapor in the canister 50 that is detected by the adsorption amount detection device becomes less than the predetermined value, the pump 61 is activated simultaneously with the start of charging. In this condition, the fuel vapor in the fuel tank 10 and the fuel vapor adsorbed by the canister 50 are treated by means of the evaporative fuel treatment apparatus 1.

While the hybrid motor vehicle is parked, the threshold value for the internal pressure in the fuel tank 10 as a threshold value for the execution of the evaporative fuel treatment, and the threshold value for the adsorption amount of the fuel vapor adsorbed by the canister 50 are modified to values less than those during traveling. At the start of next traveling of the hybrid motor vehicle, the fuel vapor amounts present in the fuel tank 10 and the canister 50 are made smaller than under the normal control.

In addition, as another control method, until the lapse of a first predetermined time from the start of charging, the passage is switched to the first passage 30 by the passage switching device 82, and at the same time, the first control valve 54 is opened and the second control valve 56 is closed. In this condition, the fuel vapor in the fuel tank 10 is treated (hereinafter, referred to as first treatment). After the lapse of the first predetermined time, the passage is switched from the first passage 30 to the second passage 80 by the passage switching device 82, and at the same time, the first control valve 54 is closed and the second control valve 56 is opened. In this condition, the fuel vapor adsorbed by the canister 50 is treated (hereinafter, referred to as second treatment). After the lapse of the second predetermined time, the pump 61 is stopped to complete the treatments of the fuel vapors.

Alternatively, the order of the treatments may be reversed. That is, the second treatment may be first performed. Subsequently, the first treatment may be performed. Furthermore, the first and second treatments may be repeated a plurality of times.

According to the evaporative fuel treatment apparatus 1, the gas separation membrane module 20 provided with the gas separation membrane 22 is used. Therefore, it is possible to sufficiently separate a fuel vapor even through a single-stage separation process. Furthermore, a fuel concentrated vapor concentrated by the gas separation membrane module 20 is returned into the fuel A in the fuel tank 10, to thereby dissolve the fuel vapor in the fuel A. Therefore, it is possible to utilize the fuel vapor again as the fuel A. In addition, this eliminates the necessity of a treatment such as compression or liquefaction of the fuel vapor and an apparatus for the treatment.

Furthermore, as a drive source for the gas separation membrane module 20, the pump 61 driven by an electric motor independent of the engine is used. Therefore, it is possible to treat a fuel vapor even when the engine is at rest.

Furthermore, when the battery 92 is charged from the commercial power source 100 while the hybrid motor vehicle is parked, electric power of the commercial power source 100 is supplied to activate the pump 61, to thereby treat the fuel vapor in the fuel tank 10 and the fuel vapor adsorbed by the canister 50 by means of the evaporative fuel treatment apparatus 1. Therefore, it is possible to treat a fuel vapor without using the motive force while the motor vehicle is driven, and by use of as little electric power as possible of the battery 92 mounted in the motor vehicle. Therefore, it is possible to improve the fuel consumption of the hybrid motor vehicle and to extend its cruising distance.

Furthermore, while the motor vehicle is parked, the fuel vapor in the fuel tank 10 and the fuel vapor adsorbed by the canister 50 are treated. Therefore, when the motor vehicle is moved next time, the amounts of fuel vapor present in the fuel tank 10 and the canister 50 are extremely small. As a result, while the motor vehicle is driving, it is possible to make extremely low the frequency with which the fuel vapor in the fuel tank 10 and the fuel vapor adsorbed by the canister 50 are treated.

Therefore, it is possible to improve the fuel consumption of the hybrid motor vehicle and to extend its cruising distance.

### Another Example

The present invention is not limited to the aforementioned embodiment.

For example, in the aforementioned embodiment, while the motor vehicle is parked, electric power supplied from the outside of the motor vehicle (that is, the home-use commercial power source 100) is used to activate the evaporative fuel treatment apparatus for a motor vehicle. However, while the motor vehicle is parked, electric power supplied from a natural-energy power generator mounted in the motor vehicle may be used to activate the evaporative fuel treatment apparatus for a motor vehicle. Here, the natural-energy power generator refers to an apparatus capable of using natural energy such as solar rays even when the motor vehicle is at rest, and includes a photovoltaic cell.

In addition, the power accumulator is not limited to a battery, but maybe a capacitor.

### INDUSTRIAL APPLICABILITY

According to the evaporative fuel treatment apparatus for a motor vehicle of the present invention, it is possible to treat an evaporative fuel without using the motive force while the motor vehicle is driven, and by use of as little electric power as possible of the power accumulator mounted in the motor vehicle. In addition, it is possible to utilize the evaporative fuel again as a fuel after it is returned to the fuel tank. Therefore, it is possible to improve the fuel consumption of the motor vehicle and to extend its cruising distance.

1. An evaporative fuel treatment apparatus for a motor vehicle that treats an evaporative fuel produced in a fuel tank mounted in a motor vehicle or an evaporative fuel in an evaporative fuel reservoir for temporarily storing the evaporative fuel produced in the fuel tank and returns the evaporative fuel to the fuel tank, wherein
the evaporative fuel treatment apparatus is activated, while the motor vehicle is parked, by use of electric power supplied from an outside of the motor vehicle or electric power supplied from a natural-energy power generator mounted in the motor vehicle.

2. The evaporative fuel treatment apparatus for a motor vehicle according to claim 1, wherein
the motor vehicle is a hybrid motor vehicle traveling on wheels that are driven with an engine and an electric motor as drive sources.

3. The evaporative fuel treatment apparatus for a motor vehicle according to claim 1 further includes
a gas separation membrane that separates the evaporative fuel into a fuel concentrated vapor and a fuel lean vapor and
a pump that is driven by the electric power to generate a pressure difference between an inflow side and an outflow side of the gas separation membrane.

4. The evaporative fuel treatment apparatus for a motor vehicle according to claim 1, wherein
the evaporative fuel treatment apparatus is activated by the electric power even if the motor vehicle is traveling, in a case where a condition for purging the evaporative fuel to the engine is not satisfied when an internal pressure in the fuel tank exceeds a predetermined value or an amount of the evaporative fuel in the evaporative fuel reservoir exceeds a predetermined value.
